(19) United States
(12) Patent Application Publication
(10) Pub. No.: US 2008/0159633 A1
(43) Pub. Date: Jul. 3, 2008

(54) Method and Apparatus for Managing Data-Analysis Parts in a Word Processor Application

(75) Inventors: Paul van Eikeren, Bend, OR (US); Joshua S. van Eikeren, Bend, OR (US)

Correspondence Address: PAUL VAN EIKEREN;BLUE REFERENCE, INC., 2554 NW 1ST ST., BEND, OR, 97701, US

(73) Assignee: Blue Reference, Inc., Bend, OR (US)

(21) Appl. No.: 11/619,326

(22) Filed: Jan. 3, 2007

(51) Int. Cl. G06K 9/62

(52) U.S. Cl. 382/209

(57) ABSTRACT

An interactive data-analysis part pane is provided for receiving and displaying a data-analysis part in a word processor application. The interactive data-analysis part pane includes a content region for receiving and displaying the data-analysis part in at least one predefined area of the word processor document in a data-analysis template. The content region shares data with the data-analysis part in the data-analysis part container and the data-analysis template comprises a word processor document comprising a data-analysis parts container.

### CROSS-REFERENCE TO RELATED APPLICATIONS

U.S. patent application Ser. No. ______ Attorney Docket No. BLUEREF-001, filed on Jan. 3, 2007 and entitled “Method and Apparatus for Utilizing an Extensible Markup Language Data Structure For Defining a Data-Analysis Parts Container For Use in a Word Processor Application,” U.S. patent application Ser. No. ______ Attorney Docket No. BLUEREF-003, filed on Jan. 3, 2007 and entitled “Object-Oriented Framework for Data-Analysis Having Pluggable Platform Runtimes and Export Services,” and U.S. patent application Ser. No. ______ Attorney Docket No. BLUEREF-004, filed on Jan. 3, 2007 and entitled “Method and Apparatus for Data Analysis in a Word Processor Application,” which are assigned to the same assignee as the present invention, are hereby incorporated, in their entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademarks Office patent or records, but otherwise reserves all copyright rights whatsoever.

### BACKGROUND

Data analysis is a process involving the organization, examination, display, and analysis of collected data using narratives, figures, structures, charts, graphs and tables. Data analyses are aided by data-analysis processors, which are computational engines, either in hardware or software, which can execute the data analysis process. High-end data-analysis processor typically have a language component like the R, S, SAS, Mathlab®, Python, and Perl families of languages. The availability of a language component facilitates data analysis in numerous ways including the following: arbitrary data transformations; allows applying one analysis result to results provides another; allows abstraction of repeated complex analysis steps; and development of new methodology.

A principal challenge of using data-analysis processors is communicating the results of data analysis to data owners. Generation of reports as part of a data analysis project typically employs two separate steps. First, the data are analyzed using a data-analysis application based on a data analysis processor. And two, data analysis results (tables, graphs, figures) are used as the basis for a report document using a word processor application. Although, many data analysis applications try to support this process by generating pre-formatted tables, graphs and figures that can be easily integrated into a report document using copy-and-paste from the data analysis application to the word processing application, the basic paradigm is to construct the report document around the results obtained from data analysis.

Another approach for integration of data analysis and report document generation is to embed the data analysis itself into the report document. The concept of “literate programming systems”, “literate statistical practice” and “literate data analysis” are big efforts in this area. Proponents of this approach advocate software systems for authoring and distributing these dynamic data-analysis documents that contain text, code, data, and any auxiliary content needed to recreate the computations. The documents are dynamic in that the contents, including figures, tables, etc., can be recalculated each time a view of the document is generated. The advantage of this integration is that it allows readers to both verify and adapt the data analysis process outlined in the document. A user can readily reproduce the data analysis at any time in the future and a user can present the data analysis results in a different medium. Accordingly, a need exists for computer-implemented applications, methods and systems that enable users to integrate data analysis and data-analysis results generation using familiar software applications like a word processor application.

Whatever the precise merits and features of the prior art in this field, the earlier art does not achieve or fulfill the purposes of the present invention. The prior art does not provide for the following:
the capability to perform word processing and data analysis within a single integrated environment;
the capability for managing data-analysis parts within a word processor application;
the capability for receiving and displaying data-analysis parts within a word processor application; and
the capability to generate and modify data-analysis parts within a word processor application.

### SUMMARY

In accordance with the present invention, the above and other problems are solved by providing an interactive action pane, an interactive data-analysis part pane, a method and computer-readable medium for execution of the method for using said interactive data-analysis part pane, and a program module to function as a data-analysis part editor.

The interactive action pane for managing data-analysis parts in a data-analysis template comprising a data-analysis parts container entails an interactive action pane comprising: at least one user interface element selected from a group comprising a menu, a toolbar, a Microsoft Office Document Action task pane, and a Microsoft Office ribbon menu; said user interface element comprising a first selection region for selecting the properties associated with the data-analysis template; and said user interface element comprising a second selection region for selecting the data-analysis part.

The interactive data-analysis part pane for receiving and displaying a data-analysis part in a word processor application entails an interactive data-analysis part pane comprising: a content region for receiving and displaying a data-analysis part in at least one predefined area of a word processor application comprising a data-analysis template; said content region shares data with the data-analysis part in the data-analysis parts container; and said data-analysis template comprises a data-analysis parts container.

The method for receiving and displaying a data-analysis part in at least one predefined area in a word processor application entails a method comprising: receiving a selection of an interactive-data analysis part pane for receiving and displaying the data-analysis part in the at least one predefined area of a word processor application, wherein the word processor application is comprised of a data-analysis template comprised of a data-analysis parts container; displaying a content region for receiving and displaying the data-analysis part in the interactive data-analysis part pane, wherein said content region shares data with the data-analysis part in the data-analysis parts container; receiving the data-analysis part in the content region; and displaying the data-analysis part within the content region of the data-analysis part pane. A computer-readable medium comprising computer-readable instructions, which when executed on a computer performs the method is also disclosed.

The interactive program module, when executed by a computer, for causing said computer to function as a data-analysis part editor for editing a data-analysis part in a word processor application entails a data-analysis part editor comprising: data input means for inputting data for defining the data-analysis part; data display means for displaying the data-analysis part; data pane binding means for communicating the data-analysis part between the data-analysis part editor and a data-analysis part pane; and data template binding means for communicating the data-analysis part between the data-analysis part editor and a data-analysis template comprising a data-analysis parts container.

### BRIEF DESCRIPTION OF THE DRAWINGS

FIG. 1 is a block diagram of a computing apparatus that may operate in one exemplary embodiment of the present invention.

FIG. 2 is a block diagram illustrating interaction between entities outlined in the claims of the invention and a word processor application, which may operate in one exemplary embodiment of the present invention.

FIG. 3A-E are illustrative examples of embodiments of interactive action panes of the invention for managing data-analysis parts in a word processor application.

FIG. 4 is an illustrative example of a first embodiment of an interactive data-analysis part pane for receiving and displaying code blocks and expression data-analysis part types.

FIG. 5 is an illustrative example of a second embodiment of an interactive data-analysis part pane for receiving and displaying code blocks data-analysis part types.

FIG. 6 is an illustration of an embodiment of an exemplary XML schema to define the data-analysis part panes of FIG. 4.

FIG. 7 is an illustrative example of an embodiment of an interactive data-analysis part pane for an expression where the data-analysis part in the content region is received from a data-analysis part editor.

FIG. 8 is an illustrative example of an embodiment of an interactive data-analysis part pane for a data-analysis part of the chemical reaction structure type and for a data-analysis part of the reaction table type.

FIG. 9 is a block diagram illustrating the elements of the method for receiving and displaying a data-analysis part in accordance with the claims.

FIG. 10 is an illustration of an embodiment of an interactive data-analysis part editor for a data-analysis part of the code block type.

FIG. 11 is an illustration of an embodiment of an interactive data-analysis part editor wherein the editor is an integrated development environment for development of data analysis parts.

### DEFINITION LIST

| Term | Definition |
|---|---|
| data analysis | As used herein, the term “data analysis” refers to the process |
| | of collecting, organizing, examining, displaying and |
| | analyzing collected data using narratives, charts, graphs or |
| | tables. Data analysis might include the following: processing |
| | data in order to draw inferences and conclusions; |
| | systematically applying statistical and logical techniques to |
| | describe, summarize, and compare data; and systematically |
| | studying the data so that its meaning, structure, |
| | relationships, origins and other properties are understood. |
| action pane | As used herein, the term “action pane” refers to a sectioned |
| | region in a graphical computer display, which may be used to |
| | enter, select or display actions to be performed by the |
| | application program. Also, sometimes referred to as a “task |
| | pane.” |
| add-in | As used herein, the term “add-in,” sometimes called a pug- |
| | in, refers to program module that extends the capabilities of |
| | an existing application |
| chemical reaction structure | As used herein, the term “chemical reaction structure” refers |
| | to a data-analysis part type for representing a chemical |
| | reaction in terms of the structures and associated metadata |
| | of the reactants and products. |
| chemical structure | As used herein, the term “chemical structure” refers to a |
| | data-analysis part type for representing the structure and |
| | associated metadata of a chemical entity. |
| chromatogram | As used herein the term “chromatogram” refers to a data- |
| | analysis part type for representing the composition and |
| | separation of entities in complex material mixtures. |
| code block | As used herein, the term “code block” refers to a logical |
| | grouping of computer-readable instructions comprising one |
| | or more lines of programming code, which may be contained |
| | in a data-analysis parts container and which may be executed |
| | by a data-analysis processor. |
| data set | As used herein, the term “data set” refers to a computer- |
| | readable collection of related data organized and structured |
| | according to one or more defined data structures including, |
| | but not limited to the following: vector, array, matrix, list, |
| | data frame, tuple, table, record, tree and graph. Data sets |
| | may be serialized, for example, to text documents in |
| | conformance to well-defined formats such as StatDataML, an |
| | XML format for statistical data, and to binary formats. |
| data-analysis part | As used herein, the term “data-analysis part” refers to a |
| | computer-readable component entity involved in data |
| | analysis including but not limited to the following: data sets, |
| | formulas, algorithms, models, code blocks, expressions, code |
| | libraries, scripts, instructions, software objects, files, dynamic |
| | and static libraries, packages, statistical components, |
| | simulation components, graphing components, database |
| | components, files, and records. |
| data-analysis part editor | As used herein, the term “data-analysis part editor” refers to |
| | an interactive program module, either as an add-in to an |
| | application or an independent software application, for |
| | editing a data-analysis part in a word processor application. |
| data-analysis part pane | As used herein, the term “data-analysis part pane” refers to a |
| | content region for receiving and displaying a data-analysis |
| | part in at least one predefined area of a word processor |
| | application comprising a data-analysis template. |
| data-analysis part type | As used herein, the term “data-analysis part type” refers to a |
| | named class of data-analysis parts. |
| data-analysis parts container | As used herein, the term “data-analysis part container” refers |
| | to a computer-readable container entity, such as an object |
| | that holds other objects, for holding one or more data- |
| | analysis parts. |
| data-analysis processor | The term “data analysis processor” refers to a computational |
| | engine for performing data-analysis on a data-analysis |
| | container for generating a data-analysis results collection. A |
| | data-analysis processor may be implemented via a data- |
| | analysis object-oriented framework comprising a collection |
| | of co-operating components implemented in hardware or |
| | software. A data-analysis processor may include a dynamic |
| | programming language, a library of methods, or a runtime |
| | with an application programming interface. |
| data-analysis template | As used herein, the term “data-analysis template” refers to a |
| | computer-readable data structure comprising a word |
| | processor document and a data-analysis parts container, |
| | where the template may serve as a master or pattern for the |
| | generation of a data-analysis results collection and/or a |
| | data-analysis results document. Data-analysis templates |
| | allow the data-analysis results collection and the data- |
| | analysis results document to have content which is structured |
| | and formatted in standardized and recognizable ways. |
| expression | As used herein, the term “expression” refers to a logical |
| | grouping of computer-readable instructions comprising one |
| | line of programming code, which may be contained in a data- |
| | analysis parts container and which may be executed by a |
| | data-analysis processor. |
| formulation table | As used herein, the term “formulation table” refers to a data- |
| | analysis part type for representing the data and metadata |
| | associated with a material formulated from a plurality of |
| | components. |
| object | As used herein, the term “object” is a principal building block |
| | in object-oriented design or programming. It refers to a |
| | computer-readable concrete realization, an instance, of a |
| | class that consists of data and the operations associated with |
| | that data. |
| process pathway | As used herein, the term “process pathway” refers to a data- |
| | analysis part type for representing the pathway of material |
| | and energy flows in a process |
| reaction table | As used herein, the term “reaction table” refers to a data- |
| | analysis part type for representing the data and metadata |
| | associated with a chemical reaction. |
| spectrum | As used herein the term “spectrum” refers to a data-analysis |
| | part type for representing the interaction of a material with |
| | energy in the electromagnetic spectrum. |
| word processor | As used herein, the term “word processor” refers to a |
| | computer application operative to provide functionality for |
| | creating, displaying, editing, formatting and printing |
| | electronic documents. |

### DETAILED DESCRIPTION

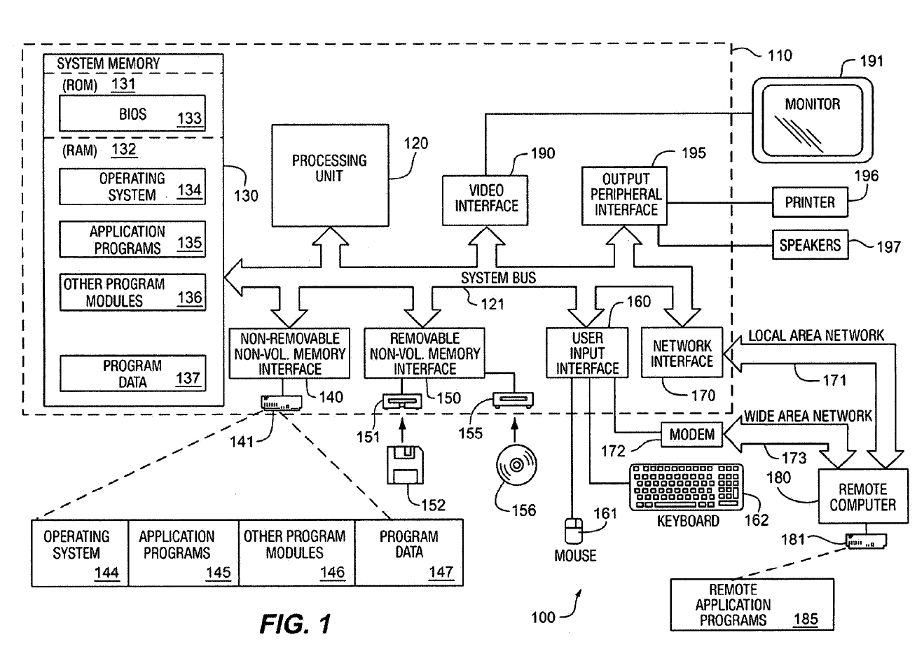

Referring now to the drawings, in which like numerals represent like elements through several figures, aspects of the present invention and the exemplary operating environment will be described. FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, and other computer instructions or components that perform particular tasks or implement particular abstract data types. The methods and apparatus may also be practiced in distributed computing environments where tasks are performed by remote processing devices that are linked through a communications network, such as web services. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates the following: operating system 134, such as the WINDOWS XP operating system from Microsoft Corporation of Redmond, Wash.; application programs 135, such as the word processor Word developed by Microsoft Corporation; other program modules 136, such as data-analysis processors including R from the R-PROJECT, S-Plus from INSIGHTFUL CORPORATION, PYTHON from the PYTHON SOFTWARE FOUNDATION, MATLAB from MATHWORKS CORPORATION, and PERL from the PERL FOUNDATION; and program data 137, such as a data-analysis template comprising a word processor document, for example in the form of a WORD word processor program document and a data-analysis parts container. It should further be appreciated that the various aspects of the present invention are not limited to word processing applications programs but may also utilize other application programs 135 which are capable of processing data-analysis parts, such as spreadsheet (e.g., EXCEL spreadsheet program from MICROSOFT CORPORATION) and presentation (e.g., POWERPOINT presentation program from MICROSOFT CORPORATION) application programs.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

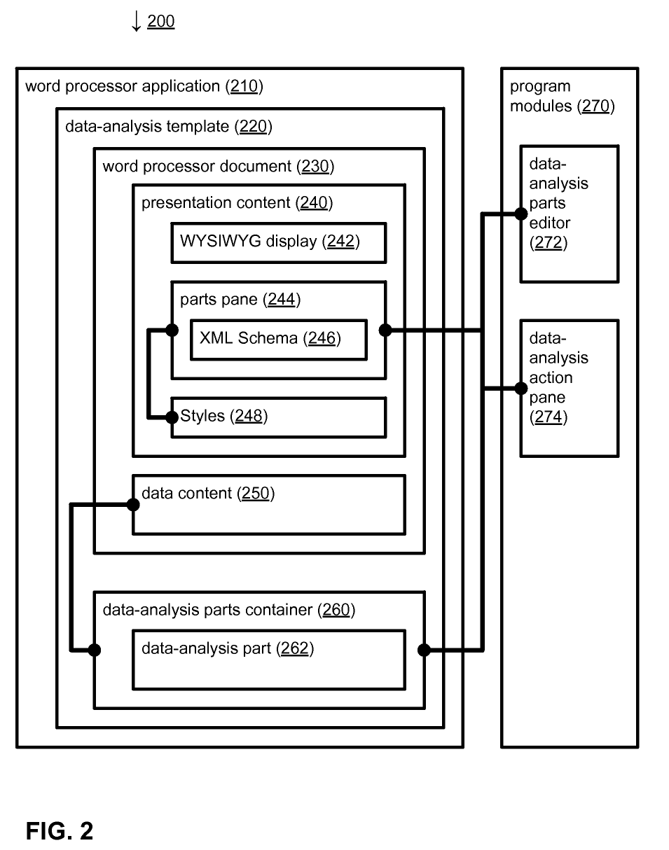

An embodiment of the present invention entails an interactive action pane for managing data-analysis parts in a data-analysis template comprising a data-analysis parts container for use in a word processor application. FIG. 2, a block diagram illustrating interaction between the elements of the invention, shows a word processor application 210 comprising a data-analysis template 220. Data-analysis templates may be used to perform data analysis to generate data-analysis results within the familiar environment of a word processor application in conjunction with a data-analysis processors. Illustrative data-analysis templates for generating data-analysis results include but are not limited to the following: data-analysis templates for assembly as electronic laboratory notebooks (for example: templates in chemistry discovery, biology discovery, chemical development, bioprocess development, formulation development, analytical development and clinical development); data-analysis templates for life sciences (for example: genomic analysis, microarray analysis, Taqman analysis, cheminformatics analysis, clinical trial design and analysis, biostatics analysis, health services and outcomes analysis, process analytical technology analysis); data-analysis templates for economics and finance (for example: loan portfolio valuation analysis, portfolio optimization analysis, risk management analysis, trading strategies analysis, consumer behavior analysis); data-analysis templates for manufacturing (for example: design and analysis of experiments, reliability and life expectancy analysis, field failure analysis, supply chain optimization analysis, demand forecasting optimization analysis, statistical process control analysis, six sigma analysis); and data-analysis templates for business performance analysis (for example: customer churn analysis, fraud detection analysis, data quality management analysis, marketing campaign analysis, customer behavior analysis). Implementation of a data-analysis template is described in further detail in co-pending U.S. patent application entitled “Method and Apparatus for Utilizing an Extensible Markup Language Data Structure to Define a Data-Analysis Parts Container for Use in a Word Processor Application,” which is expressly incorporated herein, in its entirety, by reference.

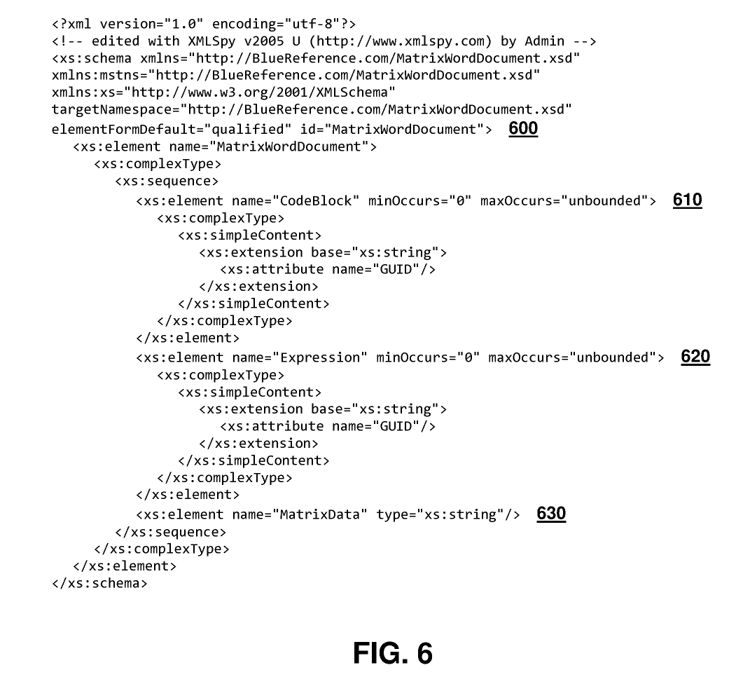

Referring to FIG. 2. a data-analysis template is comprised of a word processor document 230 and a data-analysis parts container 260. Preferred embodiments of the invention may use a word processor document 230 capable of separating the presentation content 240 from the data content 250. In an illustrative word processor document 230, the presentation content 240 may be comprised of the WYSIWYG (“what you see is what you get”) display 242 for displaying the formatted textual content of the document, a data-analysis parts pane 244 for receiving and displaying a data-analysis part, and styles 248 for applying formatting styles to the data-analysis parts pane and/or its content region. As will be illustrated in FIG. 6, a data-analysis parts pane may be defined by an XML Schema 246. The data-content 250, in the illustrative example, may operate as a means to hold the data-analysis parts container 260, which may be comprised of an XML data structure for defining the container. Implementation of a data-analysis container is described in further detail in co-pending U.S. patent application entitled “Method and Apparatus for Utilizing an Extensible Markup Language Data Structure To Define a Data-Analysis Parts Container for Use in a Word Processor Application,” which is expressly incorporated herein, in its entirety, by reference.

Referring to FIG. 2, the elements comprising the data-analysis template 220 may be operated upon with the assistance of program modules 270. Illustrative program modules include a data-analysis action pane 274 for managing data-analysis parts container 260 in the data-analysis template 220 and a data-analysis parts editor 272 for generating and modifying data-analysis parts in the data-analysis parts container 260. Program modules, such a a data-analysis action pane 274, may be implemented through the use of smart document technology, which provides an architecture to build context-sensitive data-analysis templates. Smart document solutions associate an electronic document like a word processor document 230 with an XML schema, so that presentation content 240, such as a formatted paragraph of text, may be distinguished from data content 250, such as an XML string defining a data-analysis parts container 260. It is important to note that the familiar base functionality of the word processor application is retained in a smart document solution. Smart document solutions allows programmatic customization for searching within and operating on extensible markup language (XML) nodes within a data-analysis template, which is comprised of a data-analysis parts container. Data-analysis templates may be documents in a word processor application or may be files that can be opened by a word processor application such as Word developed by Microsoft Corporation.

Smart document solutions may be created using many modern programming systems such as Microsoft Visual Basic™ 6.0, Microsoft Visual Basic .NET™, Microsoft Visual C#™.NET, Microsoft Visual J#™ or Microsoft Visual C++™ development systems. Creation of smart document solutions may be assisted by use of software development tools such as Visual Studio Tools for Office developed by Microsoft Corporation. Smart document solutions may be deployed over a corporate intranet, over the Internet, or through Web sites. Further descriptions and details for the creation of smart document solutions may be found in the book by Eric Carter and Eric Lippert entitled “Visual Studio Tools for Office: Using C# with Excel, Word, Outlook, and Infopath,” Addison Wesley Professional, Microsoft NET Development Series, 2006.

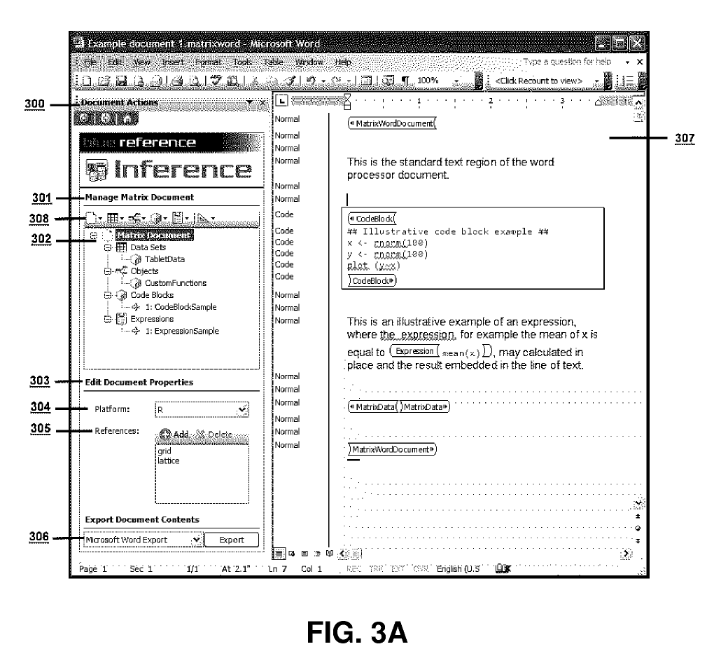

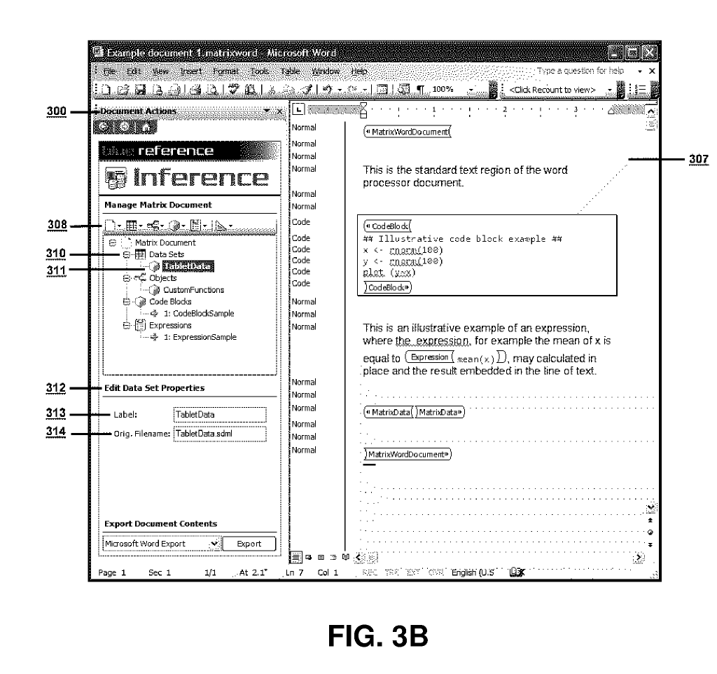

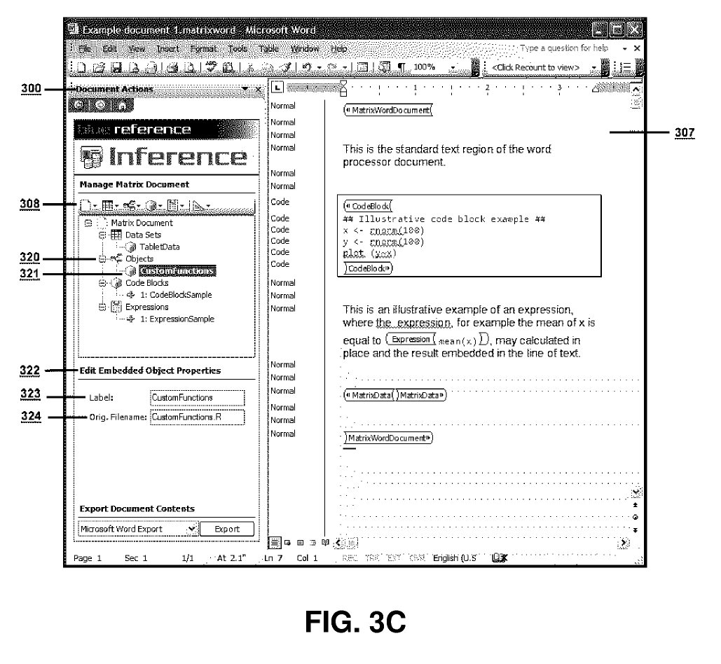

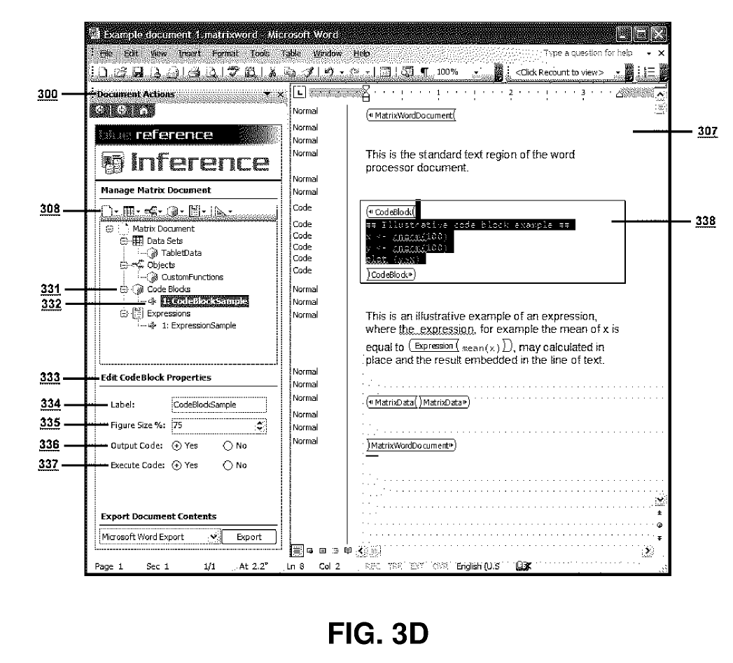

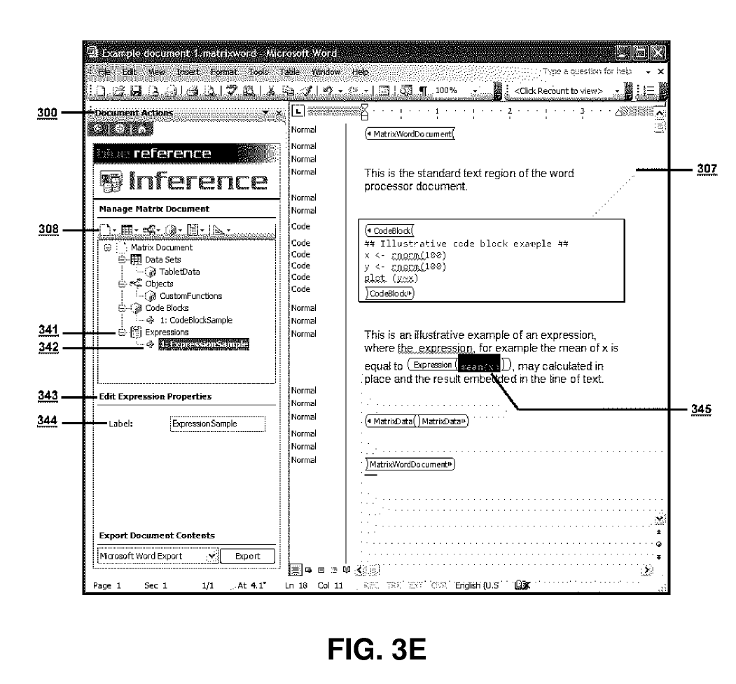

FIG. 3A through FIG. 3E are illustrative examples of embodiments of an interactive action pane for managing data-analysis parts in a word processor application. FIG. 3A illustrates an interactive action pane 300 of the user interface element type Office Document Microsoft Actions task pane and labeled “Document Actions” as an add-in to the word processor application Word Developed by Microsoft, which displays a word processor document 307. It should be noted that substantially equivalent results can be obtained by using other user interface elements including but not limited to a menu, a toolbar, and a Microsoft Office ribbon menu. The interactive action pane 300 may be comprised of a first selection region, illustrated as “Edit document properties” 303, for selecting the properties of the data-analysis template including the data-analysis processor (“Platform” 304) and ancillary packages (“References” 305) employed by the data-analysis processor for execution of data analysis. The interactive action pane 300 may be further comprised of a second selection region, illustrated as “Manage Matrix Document” 301, for selecting and operating upon the data-analysis part types and the corresponding data-analysis part. For example, the hierarchical tree labeled “Matrix Document” 302 comprised a collection of data-analysis part types (for example, “Data Sets,” “Objects,” “Code Blocks,” and “Expressions”). Within each data-analysis part type is comprised a corresponding collection of one or more data-analysis parts. The interactive action pane 300 may also have a selection region, illustrated as “Export Document Contents” 306, for generation and export of data-analysis results. Although illustrated embodiment of the invention employs Word developed by Microsoft Corporation as the word processor application, embodiments of the invention include other word processor applications, which may employ XML-based standard file structure, such as Ecma standard Office Open XML and ISO standard open document file, including but not limited to the word processors TextMaker, StarOffice, OpenOffice Writer, Ichitaro, KWord, and AbiWord. It should be further noted that the types of selection regions shown in FIG. 3A through FIG. 3E are for illustrative purposes only and are not intended to be restrictive. For example, other suitable selection region types include but are not limited to the following: popup menu, menu bar, pull-down menu, drop-down menu, window, button, radio button, check box, tree view, tabs, table, and text box.

FIG. 3B illustrates operation of the interactive action pane 300 when the data-analysis part labeled “TabletData” 311 of the data-analysis part type Data Sets 310 is selected as shown by the black highlighting. The user may operate on the selected data-analysis part of the type data set in several ways. One, the user may “Edit Data Set Properties” 312 including the “Label” 313 and the “Original Filename” 314. Alternatively, the user may bring up a menu selected from the toolbar 308 to execute selected actions which include but are not limited to the following: import data set; update data set; replace data set; delete data set; move the data set up in the order; move the data set down in the order; export data set to file; and edit data set in a data-analysis parts editor or in an integrated development environment such as Matrix Studio developed by Blue Reference Corporation. FIG. 3C illustrates operation of the interactive action pane 300 when the data-analysis part labeled “CustomFunctions” 321 of the data-analysis part type Objects 320 is selected also as shown by black highlighting. The user may operate on the selected object “CustomFunctions” 321 either through the selection region “Edit Embedded Object Properties” 322, which includes “Label” 323 and “Original Filename” 324, or through selection of a menu on the toolbar 308.

FIG. 3D illustrates operation of the interactive action pane 300 when the data-analysis part labeled “CodeBlockSample” 332 of the data-analysis part type Code Blocks 331 is selected as shown by the black highlighting. Synchronized with selection of “CodeBlockSample” 332 in the interactive action pane 300 is corresponding selection of the interactive parts pane 338 in the display of the word processor application 307. The user may operate on the selected data-analysis part of the type Code Block through the “Edit CodeBlock Properties” selection region 333, which includes management of the “Label” 334, “Figure Size” 335 for setting the output graphic relative to the width of the text in 307, “Output Code” 336 for specifying whether the text corresponding to the code block should be included in the data-analysis results document, and “Execute Code” 337 for specifying whether the text corresponding to the code block should be suppressed in the generation of the data-analysis results document. FIG. 3E illustrates operation of the interactive action pane 300 when the data-analysis part labeled “ExpressionSample” 342 of the data-analysis part type Expressions 341 is selected as shown by the black highlighting. Synchronized with selection of “ExpressionSample” 342 in the interactive action pane 300 is corresponding selection of the interactive parts pane 345 in the display of the word processor application 307. Similar to described above, the user may operate on the selected data-analysis part through the “Edit Expression Properties” selection section 343, which includes editing the “Label” 344 or through selection of the appropriate menu from the toolbar 308.

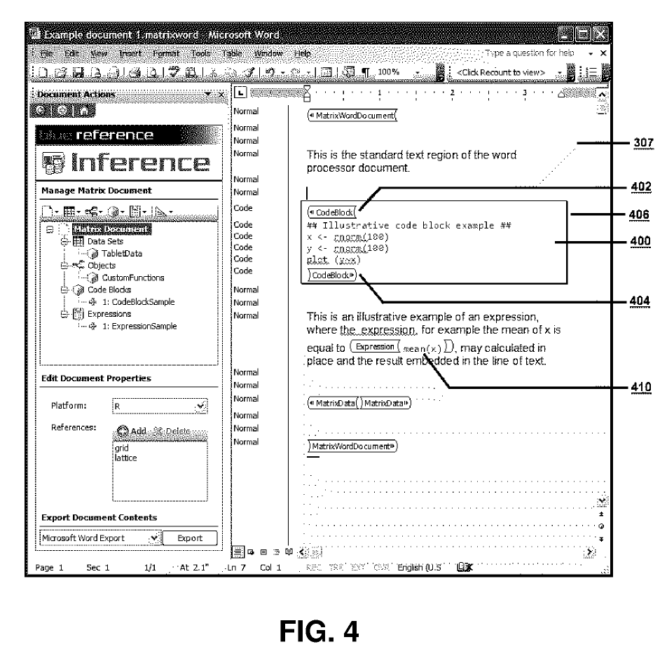

An embodiment of the invention entails an interactive data-analysis part pane for receiving and displaying a data-analysis part in a word processor application. FIG. 4 illustrates a data-analysis part pane for receiving and displaying a code block 400 in the word processor document 307. The interactive data-analysis part pane 400 is comprised of a content region bounded by the icons <|CodeBlock 402 and CodeBlock|> 404 and may be formatted by application of one or more formatting styles. Application of styles provide a means to apply consistent style elements to a data-analysis part in the content region of a data-analysis parts container including but not limited to type, size and color to the font and borders and shading to the content region. The content region of the data-analysis parts pane may be used to display and receive content associated with a data-analysis part. The content region of the data-analysis parts pane may be empty or may include content. For instance, the data-analysis parts pane 400 of the type Code Block may include several lines of “Insert Code Block line . . . ” instructions that may be replaced by several suitable lines of computer readable instructions. The interactive data-analysis pane may also have a border 406 comprised of a graphical element, which may optionally be applied via a formatting style. FIG. 4 also illustrates a data-analysis part pane for receiving and displaying an expression 410. Said part pane is bounded by a starting icon labeled “Expression” and a termination icon. The content region of said pane may also be formatted by the application of one or more formatting styles. It should also be noted that the data-analysis part pane for an expression may be surrounded with text from one or more paragraphs or may appear in a table.

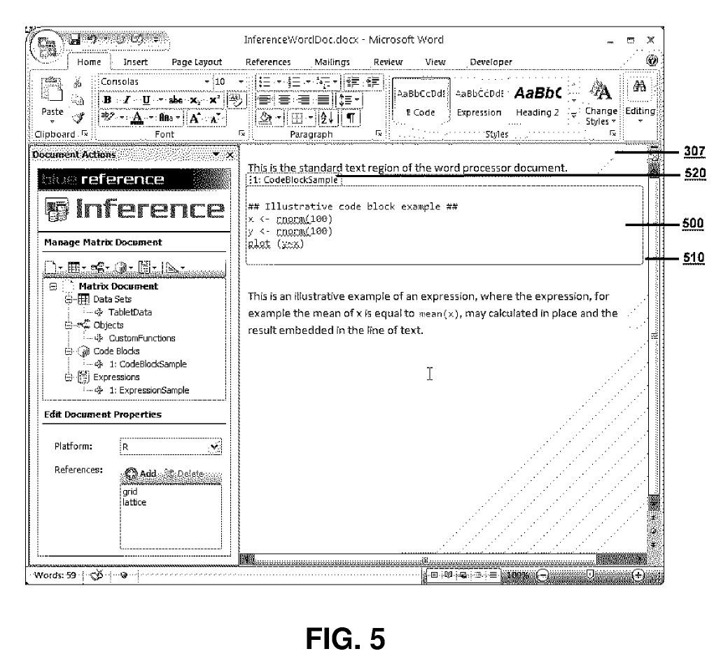

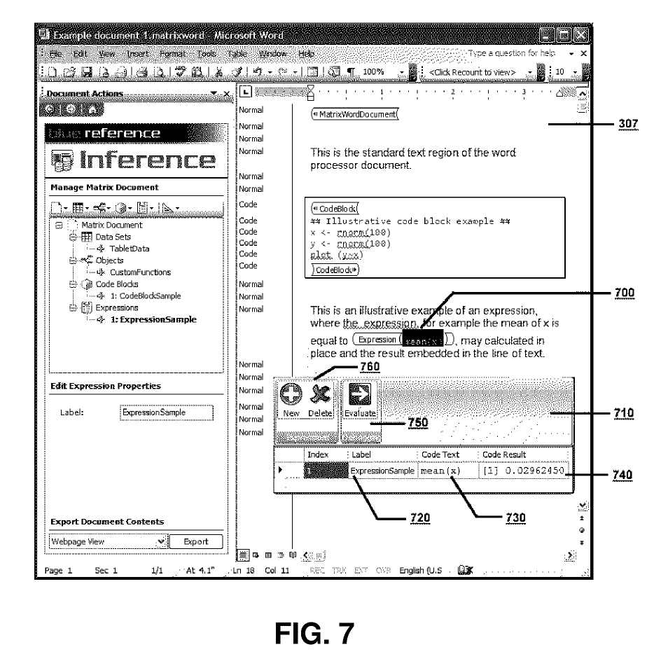

Referring now to FIG. 5, another embodiment of a data-analysis part pane 500 for use with code blocks in the word processor document 307 is shown according to an illustrative embodiment of the present invention. The data-analysis parts pane 500 includes a content region bounded by a border 510 for receiving and displaying data-analysis parts in the display of document 370. In addition, the data-analysis part pane optionally may display a label 520 identifying the data-analysis part. The content region within the data-analysis parts pane includes places for the display of other data analysis parts and running text. For instance, the data-analysis parts pane may contain other data-analysis parts panes including mixed data-analysis part types. It will be appreciated that a data analysis parts pane may be surrounded or interspersed with regions of running text tailored to the specific needs of the data analysis. For instance, the data-analysis parts pane in FIG. 5 contains data-analysis part pane 500 surrounded by separate paragraphs of running text such as “This is the standard text . . . ” and “This is an illustrative example of an expression . . . ” Those skilled in the art will recognize that embodiments of data-analysis part panes in accordance with the invention may be constructed from single or grouped content controls available in Word 2007 developed by Microsoft Corporation. In addition, a data-analysis part pane constructed from such content controls provides the capability to restrict content in accordance to preset rules. Furthermore, a data-analysis part pane constructed from such content controls may receive content directly or programmatically via, for example, a data-analysis part editor, as illustrated in FIG. 7.

FIG. 6 is an illustrative embodiment of the present invention including an Extensible Markup Language Schema to define data-analysis parts panes like those described in FIG. 4 for use in a word processing document saved by Word developed by Microsoft Corporation. FIG. 6 illustrates the organization of the schema of a MatrixWordDocument 600 that includes a parent CodeBlock element 610 with associated child attributes, a parent Expression Element 620 with associated child attributes, and a parent MatrixData element 630. The schema organization of FIG. 6 is illustrated using the W3C XML Schema Definition Language, which is an XML language for describing and constraining the content of XML documents.

In one embodiment of the invention, a data-analysis part pane may receive content directly via the graphical user interface by means including having the user directly acting on the content region by means, for example, of inputting, selecting, drawing or copy-and-pasting in the content region of the data-analysis parts pane. In another embodiment of the invention, the data-analysis part pane may receive content programmatically by, for example, mapping the content region to XML data or mapping the content region to a data-analysis part editor. FIG. 7 is an illustrative embodiment of the present invention including a data-analysis part editor 710 in a modal window useful for editing the contents of a data-analysis part pane 700 of the expression type. FIG. 7 illustrates a data-analysis parts editor 710 including a selection region for editing a label 720 and code text 730 defining the expression. FIG. 7 also illustrates that the data-analysis part editor exhibits the capability to add new or delete existing expressions 760 and the capability to dynamically evaluate the expression 750 and returning a preview of the code result 740.

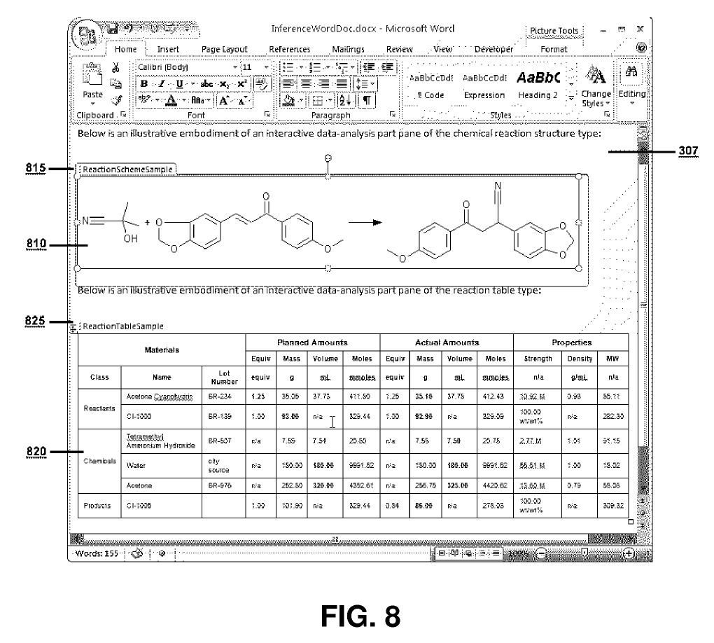

Those skilled in the art will recognize that linking a data-analysis part editor for a specific data-analysis part type with a data-analysis part pane provides a general means to display and manage a data-analysis part, including but not limited to the following: a data set; an object; a code block; an expression; a chemical structure; a chemical reaction structure; a reaction table; a formulations table; a process pathway; a spectrum of a substance; and a chromatogram of a substance. For example, FIG. 8 is a screenshot of an illustrative example of display of a word processor document 307 comprising of a data-analysis part pane for a data-analysis part of the type reaction structure 810 bearing a label entitled “ReactionSchemeSample” 815 and a data-analysis part pane for a data-analysis part of the type reaction table 820 bearing a label entitled “ReactionTableSample” 825.

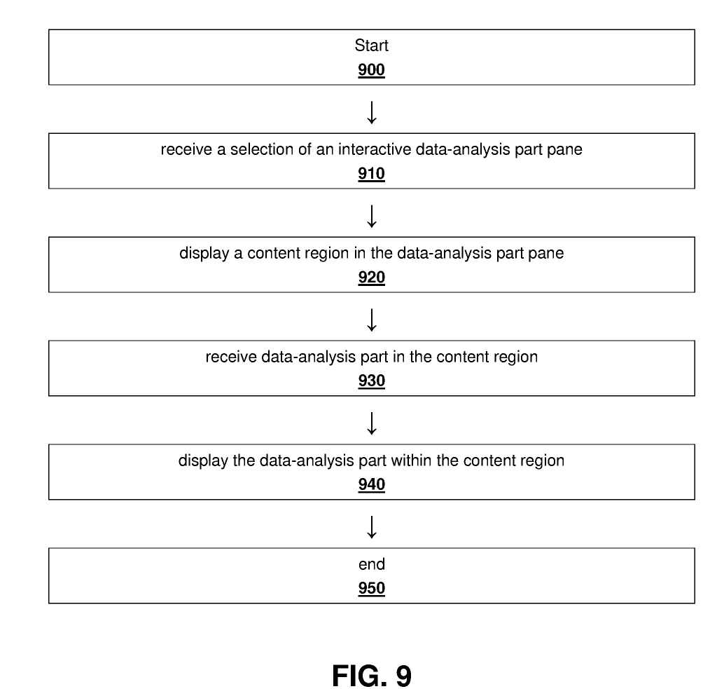

Referring now to FIG. 9, an illustrative routine will be described illustrating a process for utilizing a data-analysis parts pane for receiving and displaying a data-analysis part pane in at least one predefined area in the word processor application. It should be appreciated that although the embodiments of the invention described herein are presented in the context of the word process application Word developed by Microsoft, the invention may be utilized in other word processor applications such as StarOffice Writer developed by Sun Microsystems Corporation (also distributed as the Open Source project Open Office), spreadsheet applications such as Excel developed by Microsoft Corporation, presentation applications such as PowerPoint developed by Microsoft Corporation, drawing applications such as Visio developed by Microsoft Corporation, or database applications such as Access developed by Microsoft Corporation.

When reading the discussion of the routines presented herein, it should be appreciated that the logical operations of the various embodiments of the present invention are implemented as (1) computer-executable instructions, such as program modules, being executed by a computer and/or (2) as interconnected machine logic circuits or circuit modules within the computing system. The implementation is a matter of choice dependent on performance requirements of the computing system implementing the invention. Accordingly, the logical operation illustrated in FIG. 9, and making up an embodiments of the present invention described herein are referred to variously as operations, structural devices, acts or program modules. It will be recognized by one skilled in the art that these operations, structural devices, acts and modules may be implemented in software, firmware, in special purpose digital logic, and any combination thereof without deviating from the spirit and scope of the present invention as recited within the claims set forth herein.

Referring now to FIG. 9, the routine starts 900 with operation 910, wherein the method entails receiving a selection of an interactive data-analysis part pane for receiving and displaying a data-analysis part in at least one predefined area of a word processor application, wherein the word processor application is comprised of a data-analysis template comprised of a data-analysis part container. Embodiments of the present invention provide means for selecting and positioning the data-analysis part pane at a predefined area of the word processor application. For example referring to FIG. 3D, a user may select a location for insertion of the data-analysis part pane of the type code block by first placing the display cursor at a desired region of the graphical display of the word processor document 307. At that point, a user may invoke a menu of choices by several means, including but not limited to the following: selection of a menu from an actions pane tool bar 308, “right clicking” on the data-analysis part type identifier 331, and “right clicking” at the point of the cursor in the graphical display of the word processor document. Such resulting menus may provide multiple options including the capability to insert a new data-analysis part from a choice of data-analysis part panes and/or data-analysis part pane types. The newly inserted data-analysis part pane may contain an empty content region or it may contain a pre-constructed entry, which may be edited subsequently.

The routine starting at 900 continues from operation 910 to operation 920, wherein the method entails displaying a content region for receiving and displaying the data-analysis part in the interactive data-analysis part pane, wherein said content region shares data with the data-analysis part in the data-analysis parts container. Those skilled in the art will recognize that sharing data between the content region of the data-analysis part pane and the corresponding data-analysis part in the data-analysis part container, particularly a data-analysis part container comprised of an XML data structure, provides a means to manage the content in the data-analysis part pane in an object-oriented manner, which in turn provides for programmatic access to the content in the data-analysis part pane. By way of illustration, sharing of data between the data-analysis part pane and the data-analysis part container may be achieved via data binding. For example, U.S. Patent application 2006/0150085, entitled “Data Binding in a Word-Processing Application,” details examples how links or data binding may be established between the contents of data and a presentation surface of a word processor application.

The routine starting at 900 continues from operation 920 to operation 930, wherein the method entails receiving the data-analysis part in the content region, which may be comprised of selecting the content region within the data-analysis part pane and then receiving the appropriate data-analysis part type from one or more sources. Data-analysis part types which may be received include but are not limited to a data set, an object, a code block, an expression, a chemical structure, a chemical reaction structure, a reaction table, a formulations table, a process pathway, a spectrum of a substance, and a chromatogram of a substance. Such source may include one or more actions generated with a computer keyboard, a computer mouse, the computer clipboard, a data-analysis part editor, an integrated development environment application for developing data-analysis parts and an independent data source. Illustrative examples of independent data sources include, but are not limited to web page, a web service, a database service, a local application service, a remote application service and an auxiliary application. It should also be noted that embodiments of the present invention contemplate receiving a data-analysis part in the content region of the data-analysis part pane by communicating information to the data-analysis part container, which is linked (data-binding) to the data-analysis part pane.

The routine starting at 900 continues from operation 930 to operation 940, wherein the method entails displaying the data-analysis part with the content region of the data-analysis part pane. In one embodiment of the invention, the data-analysis part pane may display text (for example, code blocks and expressions), which may be displayed as plain text or rich text with associated formatting based on styles. In another embodiment of the invention, the data-analysis part pane may display text in table (for example, data sets, reaction table, formulations table), which may also be formatted based on styles. In an additional embodiment of the invention, the data-analysis part pane may display a graph (for example, a spectrum of a substance, a chromatogram of a substance), which is formatted and labeled to specific requirements. And a further embodiment of the invention, the data-analysis part pane may display a graphic image to meet specific data-analysis requirements (for example, a chemical structure, a reaction structure, a process pathway). In one embodiment of the invention, two generic data-analysis part panes, one for static rich text and the other for static bitmap images, are used to display the range of data-analysis parts outlined above. Program modules may be used to transform data-analysis parts in the data-analysis part container to corresponding static rich text and static images. In another embodiment of the invention, custom data-analysis part panes are used and the display is dynamically generated by the data-analysis part pane from the data-analysis part.

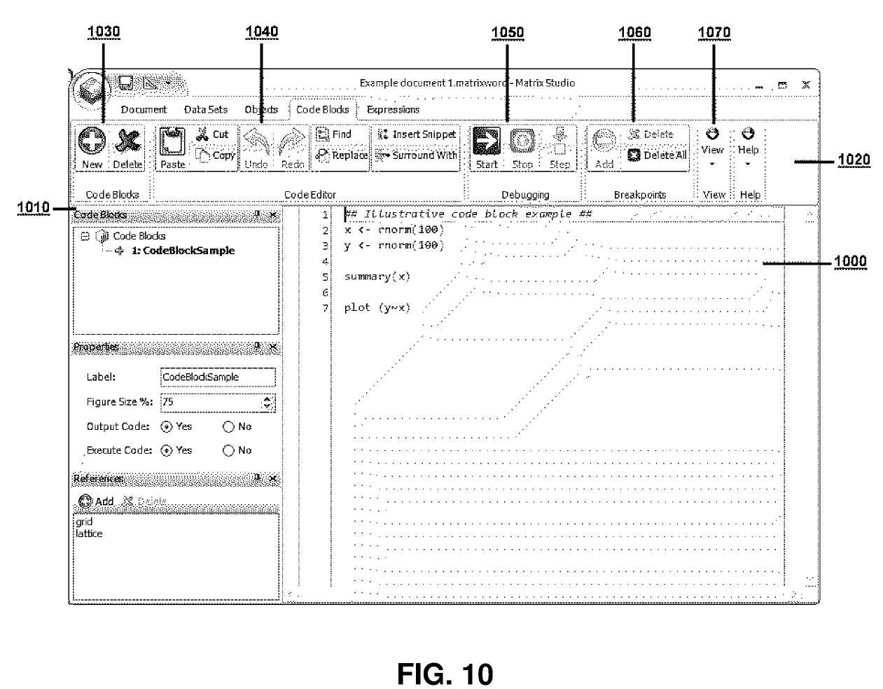

Referring now to FIG. 10, a screenshot of an interactive program module, which when executed by a computer allows said computer to function as a data-analysis part editor, illustrates an exemplary embodiment of a data-analysis part editor for editing a data-analysis part of the code block type in a word processor application. Embodiments of data-analysis part editors in accord with the claims of the invention are comprised of the following: a data input means, and optionally a data editing means, for inputting data for defining the data-analysis part; a data display means for displaying the data-analysis part; a data pane binding means for communicating the data-analysis part between the data-analysis part editor and a data-analysis part pane; and a data template binding means for communicating the data-analysis part between the data-analysis part editor and a data-analysis template comprising a data-analysis part container. FIG. 10 illustrates an exemplary data-analysis part editor in a modal window comprising a data input means comprising an input editing region 1000, an interactive action pane 1010, and a toolbar/menu 1020 for adding/deleting code blocks 1030, code editor support 1040 in the form of cutting and pasting, undo and redo, find and replace and support for adding code snippets, a debugger 1050, and a capability to set breakpoints for the debugger 1060. The exemplary data-analysis part editor is comprised of a data display region 1000, which may include syntax color highlighting to aid writing and interpreting code blocks. The exemplary data-analysis part editor has means to communicate to data-analysis part displayed in 1000 and the data associated with the interactive action pane 1010 to either a data-analysis part pane or to the computer-readable XML data structure of a data-analysis part container.

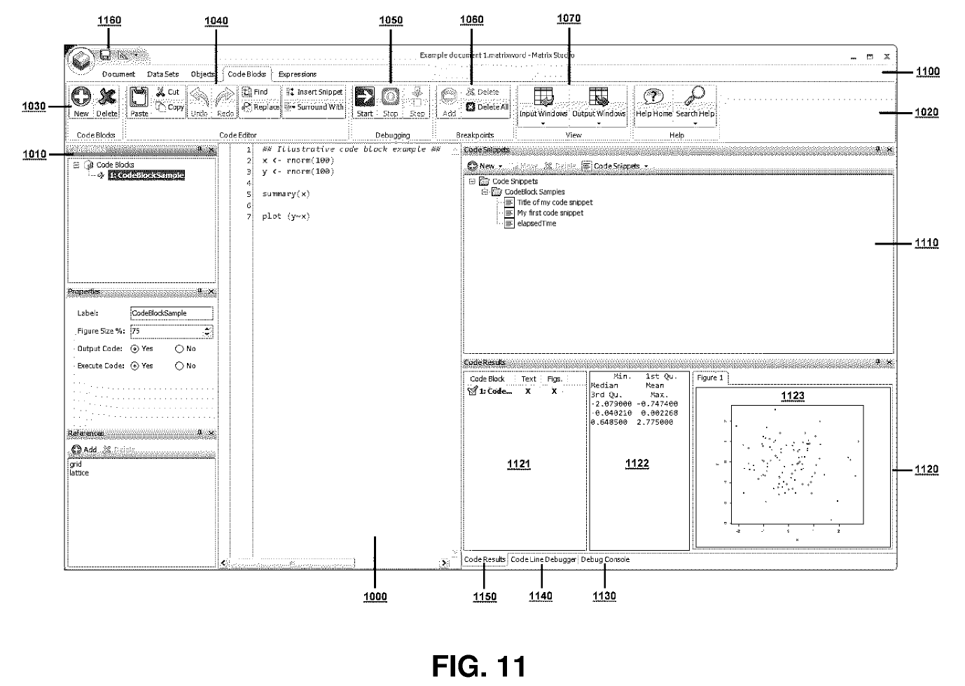

Those skilled in the art will recognize that data-analysis part editors specific for generating and modifying a given data-analysis part type, including all the data-analysis part types outlined earlier including but not limited to a data set, an object, a code block, an expression, a chemical structure, a chemical reaction structure, a reaction table, a formulations table, a process pathway, a spectrum of a substance, and a chromatogram of a substance, may be used as components in embodiments of the invention. Such data-analysis part editors may be constructed using standard programming techniques using languages such as C++, Visual Basic, C# and J#. Said data-analysis part editors may take a number of forms, including but not limited to the following: user interface elements for editing on an interactive action pane; an editor in a modal windows, as in FIG. 10; an independent data-analysis part editor application in conjunction with a means to communicate with the data-analysis part pane and the data-analysis part container; and an integrated development environment (IDE) for development of data analysis parts. FIG. 11 shows a screenshot of an illustrative IDE for development of data-analysis parts, labeled “Matrix Studio.” Such an IDE provides a means for generating and modifying data-analysis parts in a single integrated environment, which improves the efficiency of the user/programmer. The data-analysis parts IDE is comprised of a series of top-level tabbed panels 1100 for selection of editing actions upon the word processor document or different data-analysis part types including data sets, objects, code blocks, which has been selected, and expressions. FIG. 11 details one such tabbed pane labeled “Code Blocks.” Said illustrative pane comprises an IDE for development of code blocks comprised of five principal elements: (1) a ribbon 1020 for display and selection of functions and actions which may be useful to development of the data-analysis part; (2) an action pane 1010 for managing data-analysis parts of the code block type in a data-analysis template comprising a data-analysis part container; (3) an editor 1000 for generating and editing a code block with line numbering and syntax highlighting; (4) an input window 1110 for creating, managing and storing code block snippets for insertion into code blocks; and (5) an output window 1120 comprising a set of tabbed panes for code results 1150 for managing the results of execution of code blocks, a code line debugger 1140 for managing the results of stepping through the code to a breakpoint, and a debug console 1130 for allowing the user to perform command line execution of code. For example, the code results tab 1150 is comprised of a code block listing panel 1121 for indicating whether execution of a code block results in corresponding text and/or graphical output, a text output panel 1122 containing the text output for execution of a selected code block, and tabbed panels of graphic output 1123 (figures) resulting from execution of a selected code block.

What is claimed is:

1. An interactive action pane for managing data-analysis parts in a data-analysis template comprising a data-analysis parts container, the interactive action pane comprising:
at least one user interface element selected from a group comprising a menu, a toolbar, a Microsoft Office Document Actions task pane, and a Microsoft Office ribbon menu;
said user interface element comprising a first selection region for selecting the properties associated with the data-analysis template; and
said user interface element comprising a second selection region for selecting the data-analysis part type.

2. The interactive action pane of claim 1, wherein the user interface element comprises an add-in for a word processor application.

3. The interactive action pane of claim 2, wherein the word processor application comprises Word developed by Microsoft.

4. The interactive action pane of claim 1, wherein the selection region is comprised of at least one from a group comprising popup menu, menu bar, pull-down menu, drop-down menu, window, button, radio button, check box, tree view, tabs, and text box.

5. The interactive action pane of claim 1, wherein the first selection region comprises at least one property selected from a group of properties comprising:
data-analysis processor associated with the data-analysis template;
initialization conditions for said data-analysis processor; and
ancillary packages needed by data-analysis processor.

6. The interactive action pane of claim 1, wherein the second selection region comprises at least one data-analysis part selected from a group of data-analysis part types comprising:
data set part type for inserting a computer-readable data structure in the data-analysis template;
object part type for inserting a serialized object in the data-analysis template;
code block part type for inserting a code block in the data-analysis template;
expression part type for inserting an expression in the data-analysis template;
chemical structure part type for inserting a chemical structure in the data-analysis template;
chemical reaction structure part type for inserting a chemical reaction in the data-analysis template;
reaction table part type for inserting a reaction table in the data-analysis template;
formulation table part type for inserting a formulation table in the data-analysis template;
process pathway part type for inserting a process pathway in the data-analysis template;
spectrum part type for inserting a spectrum of a substance in the data-analysis template; and
chromatogram part type for inserting a chromatogram of a substance in the data-analysis template.

7. An interactive data-analysis part pane for receiving and displaying a data-analysis part in a word processor application, the interactive data-analysis part pane comprising
at least one content region for receiving and displaying a data-analysis part in at least one predefined area of a word processor application comprising a data-analysis template,
said content region capable of sharing data with the data-analysis part in the data-analysis parts container; and
said data-analysis template comprises a data-analysis parts container.

8. The interactive data-analysis part pane of claim 7, wherein the data-analysis part is one of a group of data-analysis part types, the group comprising: a data set; an object; a code block; an expression; a chemical structure; a chemical reaction structure; a reaction table; a formulations table; a process pathway; a spectrum of a substance; and a chromatogram of a substance.

9. The interactive data-analysis part pane of claim 7, wherein the content region may be formatted by application of a predetermined formatting style.

10. The interactive data-analysis part pane of claim 7, wherein the data-analysis part in the content region is received from at least one data source external to the data-analysis template.

11. The interactive data-analysis part pane of claim 7, wherein the data-analysis part in the content region is received from a data-analysis part editor.

12. The interactive data-analysis part pane of claim 7, wherein the data-analysis part in the data-analysis parts container is received from a data-analysis part editor.

13. The interactive data-analysis part pane of claim 7 further comprising a boundary for defining the content region for receiving and displaying a data-analysis part.

14. The interactive data-analysis part pane of claim 13, wherein the boundary for defining the content region for receiving and displaying the data-analysis part is selected from a group comprising:
an icon; and
a graphical element.

15. The interactive data-analysis part pane of claim 7, further comprising a pane event handler for selecting the data-analysis part pane.

16. The interactive data-analysis part pane of claim 15, wherein the pane event handler provides at least one event for an action on the selected pane selected from a group, the group comprising:
a means for deleting the pane;
a means for copying the pane to the clipboard;
a means for dragging the selected pane to a new region in the word processor application; and
a means for copying and pasting the selected pane to a new region in the word processor application.

17. A method for receiving and displaying a data-analysis part in a word processor application, the method comprising:
receiving a selection of at least one interactive data-analysis part pane for receiving and displaying the data-analysis part in at least one predefined area of a word processor application, wherein the word processor application is comprised of a data-analysis template comprised of a data-analysis parts container;
displaying at least one content region for receiving and displaying the data-analysis part in the interactive data-analysis part pane, wherein said content region is capable of sharing data with the data-analysis part in the data-analysis parts container;
receiving the data-analysis part in the content region; and
displaying the data-analysis part within the content region of the data-analysis part pane.

18. The method of claim 17, wherein receiving a selection of at least one interactive data-analysis part pane comprises:
selecting a location for insertion of the data-analysis part pane in the word processor application;
selecting a data-analysis part pane type from a plurality of data-analysis part pane types; and
receiving the data-analysis part pane at the location for insertion of the data-analysis part pane in the word processor.

19. The method of claim 17, wherein receiving the data-analysis part in the content region comprises:
selecting the content region of the data-analysis part pane; and
receiving the data-analysis part from at least one data source.

20. The method of claim 19, wherein the at least one data source is selected from a group comprising:
a computer keyboard;
a computer mouse;
a computer clipboard;
a data-analysis part editor; and
an integrated development environment application for developing data-analysis parts.

21. The method of claim 17, wherein receiving the data-analysis part in the content region comprises receiving at least one data-analysis part selected from a group, the group comprising: a data set; an object; a code block; an expression; a chemical structure; a chemical reaction structure; a reaction table; a formulations table; a process pathway; a spectrum of a substance; and a chromatogram of a substance.

22. The method of claim 17, wherein displaying the data-analysis part within the content region of the data-analysis part pane further comprises formatting the content region in accordance with a predetermined formatting style.

23. A computer-readable medium comprising computer-readable instructions, which when executed on a computer performs a method for receiving and displaying a data-analysis part in a word processor application, the method comprising:
receiving a selection of at least one interactive data-analysis part pane for receiving and displaying the data-analysis part in at least one predefined area of a word processor application, wherein the word processor application is comprised of a data-analysis template comprised of a data-analysis parts container;
displaying at least one content region for receiving and displaying the data-analysis part in the interactive data-analysis part pane, wherein said content region is capable of sharing data with the data-analysis part in the data-analysis parts container;
receiving the data-analysis part in the content region; and
displaying the data-analysis part within the content region of the data-analysis part pane.

24. An interactive program module, when executed by a computer, for causing said computer to function as a data-analysis part editor for editing a data-analysis part in a word processor application, said data-analysis part editor comprising:
data input means for inputting data for defining the data-analysis part;
data display means for displaying the data-analysis part;
data pane binding means for communicating the data-analysis part between the data-analysis part editor and a data-analysis part pane in the word processor application; and
data template binding means for communicating the data-analysis part between the data-analysis part editor and a data-analysis part container in a data-analysis template comprising a word processor document and a data-analysis parts container.

25. The interactive program module of claim 24, wherein the data-analysis part is selected from a group of data-analysis part types, the group comprising: a data set; an object; a code block; an expression; a chemical structure; a chemical reaction structure; a reaction table; a formulation table; a process pathway; a spectrum of a substance; and a chromatogram of a substance.

26. The interactive program module of claim 24, wherein the data input means is an integrated development environment for development of data-analysis parts.

27. The interactive program module of claim 24, wherein the data input means comprises at least one selected from a group comprising: an interactive action pane comprising a data-analysis part editor, a modal window comprising a data-analysis part editor, an independent software application comprising a data-analysis part editor, a spreadsheet software application comprising a data-analysis part editor, a chemical structure drawing software application comprising a data-analysis part editor, a design of experiments software application comprising a data-analysis part editor, and a statistical analysis software application comprising a data-analysis part editor.

28. The interactive program module of claim 24 further comprising data edit means for modifying data for defining the data-analysis part.
